(19) United States
(12) Patent Application Publication
(10) Pub. No.: US 2008/0215398 A1
(43) Pub. Date: Sep. 4, 2008

(54) SYSTEM AND METHOD FOR USING A COMPONENT BUSINESS MODEL TO MANAGE AN ENTERPRISE

(76) Inventors: David L. Cohn, Dobbs Ferry, NY (US); Robert Delamarter Dill, Raleigh, NC (US); David Bernard Flaxer, Dobbs Ferry, NY (US); George M. Galambos, Montreal (CA); Robert H. Guttman, Stamford, CT (US); Raman Harishankar, Blacklick, OH (US); David Robert Kress, Carmel, IN (US); Clifford Alan Pickover, Yorktown Heights, NY (US); Guy Jonathan James Rackham, New York, NY (US); Shanker Ramamurthy, New York, NY (US); John R. Smith, New York, NY (US); Stephen Michael Smith, Westlake Village, CA (US); John George Vergo, Yorktown Heights, NY (US)

Correspondence Address: WHITHAM, CURTIS & CHRISTOFFERSON, P.C., 11491 SUNSET HILLS ROAD, SUITE 340, RESTON, VA, 20190, US

(21) Appl. No.: 12/053,986

(22) Filed: Mar. 24, 2008

Related U.S. Application Data
(63) Continuation of application No. 11/202,377, filed on Aug. 12, 2005.

(51) Int. Cl. G06Q 10/00

(52) U.S. Cl. 705/7

(57) ABSTRACT

A method and system are described for using the structure and relationships between components in a component business model of an enterprise to assign components providing monitoring data to a management component. In response to the monitoring data, the management component executes a business rule invoking a service that alters a behavior of the enterprise. The management component contains data rules limiting the information provided by the assigned components, analysis rules defining the interaction between components, and report rules for consolidating recommendations for altering behavior of the enterprise, including decisions to invest in certain aspects of the business, to reengineer certain processes of the business, and to alter operation of certain aspects of the business.

This invention is related to commonly owned patent application Ser. No. 11/176,371 for “SYSTEM AND METHOD FOR ALIGNMENT OF AN ENTERPRISE TO A COMPONENT BUSINESS MODEL” which is incorporated by reference herein.

### BACKGROUND OF THE INVENTION

1. Field of the Invention

The present invention generally relates to techniques for managing a business, and more particularly to techniques for managing a business that leverage the organizing principles of a component business model.

2. Background Description

The problem solved by this invention is the general problem of how to manage a large, complex enterprise. Management is a varied and wide-ranging discipline, and many approaches to management and techniques for management are known in the prior art. However, the invention does not begin with a general approach to management. Instead, it begins by observing the systematic and comprehensive representation of an enterprise provided by a component business model (CBM) as described in related patent application Ser. No. 11/176,371 for “SYSTEM AND METHOD FOR ALIGNMENT OF AN ENTERPRISE TO A COMPONENT BUSINESS MODEL” (hereafter termed “the above referenced foundation patent application”). CBM provides a logical and comprehensive view of the enterprise, in terms that cut across-commercial and non-profit enterprises in general and industries in particular. The component business model as described in the above referenced foundation patent application is based upon a logical partitioning of business activities into non-overlapping managing concepts, each managing concept being active at the three levels of management accountability: providing direction to the business, controlling how the business operates, and executing the operations of the business. The term “managing concept” is specially defined as described in the above referenced foundation patent application, and is not literally a “managing concept” as that phrase would be understood in the art. For the purpose of the present invention, as for the related invention, “managing concept” is the term associated with the following aspects of the partitioning methodology. First, the methodology is a partitioning methodology. The idea is to begin with a whole and partition the whole into necessarily non-overlapping parts. Second, experience has shown that the partitioning process works best when addressed to an asset of the business. The asset can be further described by attributes. Third, the managing concept must include mechanisms for doing something useful with the asset. For a sensibly defined managing concept these mechanisms must cover the full range of management accountability levels (i.e. direct, control and execute). Managing concepts are further partitioned into components, which are cohesive groups of activities. The boundaries of a component usually fall within a single management accountability level. It is important for the utility of the CBM model to emphasize that the boundaries between managing concepts (and between components within managing concepts) are logical rather than physical.

A frequent difficulty with prior art management techniques, and in particular techniques that focus on the processes of a business, is that the subject matter to be managed is open ended. It is very difficult to draw a boundary around the enterprise and have some clarity as to what is to be managed.

### SUMMARY OF THE INVENTION

It is therefore an object of the invention to develop a management strategy based upon a representation of the enterprise that is stable and complete.

The invention assumes that the enterprise, or a substantial part of the enterprise, has been modeled using the component business model (CBM) technique as described in the above referenced foundation patent application. An aspect of CBM of particular importance for the present invention is that the CBM partitioning technique—beginning with a whole and segmenting that whole into non-overlapping parts—provides a complete set of components for the enterprise.

Experience has shown substantial stability of the CBM enterprise structure within and across industries, although the CBM enterprise structure is the product of an iterative process that is continuing. But while successive iterations may refine the structure, each iteration is in principle complete, because of the partitioning logic of CBM. It is unlikely that any process-based description of the business could make this claim. Further, the completeness of the component description of a business in CBM leads to a corresponding completeness in the description of interactions between components. Also, CBM may be used to monitor the enterprise as described in commonly owned patent application Ser. No. 11/______ entitled “Method and System for Enterprise Monitoring Based on a Component Business Model.” The CBM monitor presents critical information about the business, and this information is then used to manage the business. The use of CBM as a monitoring method is recommended, but not required for the use of CBM to manage the enterprise. That is, other monitoring techniques and sources of information can be used to monitor the enterprise.

An aspect of the invention is a method of managing an enterprise by identifying metrics describing the enterprise, associating the identified metrics with components in a component business model of the enterprise, analyzing data provided by said metrics, and recommending action by components in response to the analysis. Analyzing and recommending are performed by one or more management and control components, which receive all monitoring data necessary to manage the enterprise. Each of these management and control components is characterized by all of the following attributes: it receives monitoring data from other components; it contains a set of business rules that are executed in response to received data; and it issues invocations to other components that alter the behavior of parts of the business that were monitored by the metrics. An example of an invocation would be a recommendation for process re-engineering of a component, or a message to a manager of a component. A message may also be sent to a software agent empowered to control a device or take any other recommended action.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a schematic showing the organizing concept of the invention.

FIG. 2 is a diagram of a component map showing a management component taking input from other components.

FIG. 3 is a diagram of a component map showing a CBM management and control hierarchy.

FIG. 4 is a flow chart showing operation of the invention.

FIG. 5 is a diagram showing how the invention is related to CBM.

FIG. 6 is the diagram of FIG. 2 further annotated to show the significance of the accountability level of components providing input to the management component.

### DETAILED DESCRIPTION OF A PREFERRED EMBODIMENT OF THE INVENTION

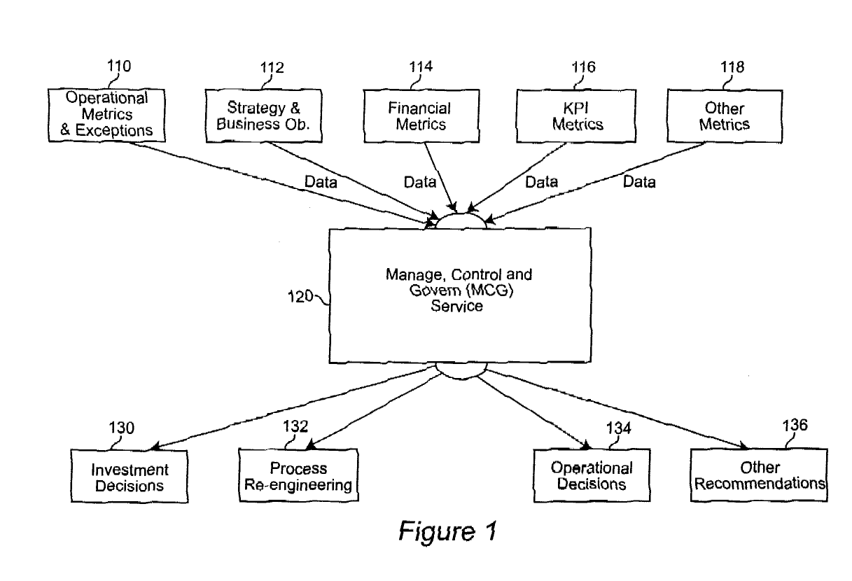

The overall nature of the invention is shown in FIG. 1. A component 120 for managing, controlling and governing (MCG) the enterprise is supported by operational metrics and exceptions 110, strategy and business objectives of the enterprise 112, financial metrics 114, key performance indicator metrics 116, and other metrics 118 available to the enterprise or later added. The MCG component 120 then provides the analysis that results in investment decision recommendations 130, recommendations for process re-engineering 132, operational decisions or recommended changes in operational decision making 134, or other recommendations 136 for improved management of the enterprise.

These metrics can either be uniquely associated with a single component or can be associated with multiple components. When a metric is produced (measured, acquired or generated through an analytic technique), it is mapped to one or more management components by a mapping service. The mapping service notifies each of the associated management components of the metric and value. The management component then executes a series of business rules. The business rules contain the logic for determining which components need to be managed, and how they need to change their behavior in response to the metric and value. The management component then issues the necessary service invocations to alter the execution of the affected components. Note that the affected components can include other management components as well as “direct” components (i.e. components at the management accountability level of “Direct”) that set strategy and policy within the enterprise. Typically, however, it will be the “execute” components that will have their operations altered in response to changes driven by the metrics.

CBM is a modular decomposition of an enterprise, with the components being comprised of one or more services that are provided to other parts of the enterprise or to customers and/or clients of the enterprise. In providing a service, a component may rely upon services provided by other components. The services provided by a component may include one or more metrics including but not limited to those shown in FIG. 1: business strategy and objectives 112; operational metrics 110; financial metrics 114; KPI metrics 116; and other metrics 118 including Capability Maturity Model assessments and Business Service Level Agreements (BSLAs) which are associated with the services contained within the business components.

An aspect of the invention is that specific, named components in a component business model of the enterprise are given the responsibility for the management of other components of the enterprise.

The management components have a unique combination of characteristics that distinguishes them from other components, namely:
They take as input data from other components. This data may be supplied in accordance with the CBM monitoring patent, of may come in a variety of forms such as messages, reports or other communications means.
The data provided to the managing components are those necessary to manage components of the enterprise. Examples include, but are not limited to, capital allocation, capacity for product or service delivery, revenue, key performance indicators (e.g. customer satisfaction). The data is provided at a frequency necessary to monitor the enterprise and manage the enterprise by responding to the monitoring information. Depending on the specific data and part of the business the frequency can vary from “instantaneous” (e.g. is the production line operational or not) to periodic (e.g. annual capital allocation decisions from senior management).
The management components contain a set of business rules that are executed in response to data from other components of the business.
Executing the business rules results in service invocations that alter the behavior of the parts of the business that execute their respective responsibilities.

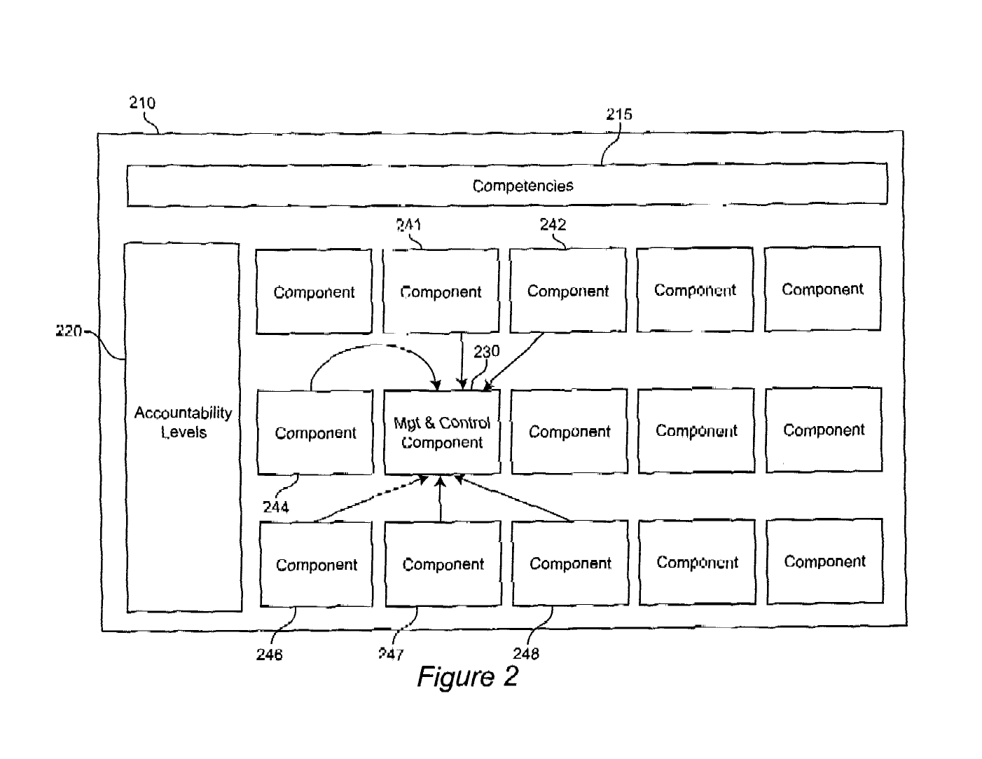

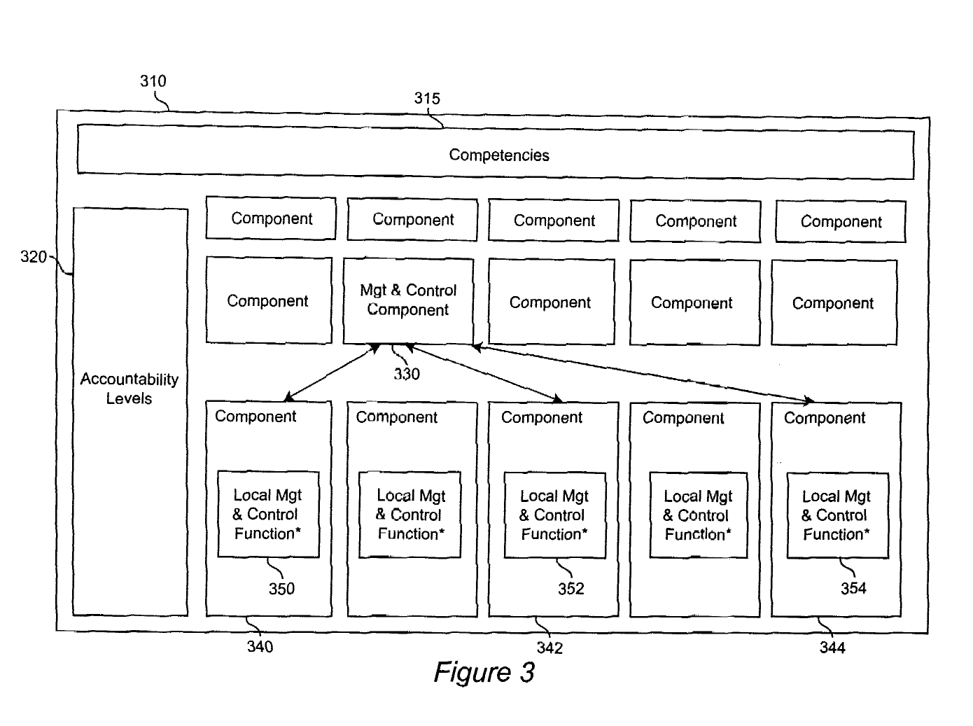

Turning now to FIG. 2 there is shown a conceptual schematic 210 of a component map for a business having competencies 215 and management accountability levels 220. Management and control component 230 receives metric information from components (241, 242, 244, 246, 247 and 248) arrayed by competency 215 and management accountability level 220 as represented on component map 210. The data received enables the management and control component 230 to analyze the business. As a result of this analysis, as shown in FIG. 3 with reference to component map 310 having competencies 315 and accountability levels 320, a management and control component 330 directs components (e.g. 340, 342 and 344) to take action via their respective local management and control functions (e.g. 350, 352 and 354) each of which maintains local rules that determine management and control of the component. It should be noted that the management and control functions of centralized component 330 may alternatively be distributed to the local management and control function of individual components (e.g. item 350).

A second aspect of the invention is that the invention uses business service level agreements (BSLAs) to codify the dynamic relationship between components and their services in a component business model. The BSLAs and their terms are monitored and the results are combined with other component-specific data to make management decisions. BSLAs can be used to monitor and manage the services of an enterprise. Such a monitored and managed service could be the basis for an outsourcing arrangement, and could define the measurements used in a value pricing deal.

BSLAs provide performance goals and implied metrics for every service. BSLAs enable “black box” operation of services, where the only measure of success or failure is whether they meet their BSLAs. Services that fail to meet their BSLAs, or that are inefficient in their operations, become candidates for outsourcing or other management decisions such as process re-engineering.

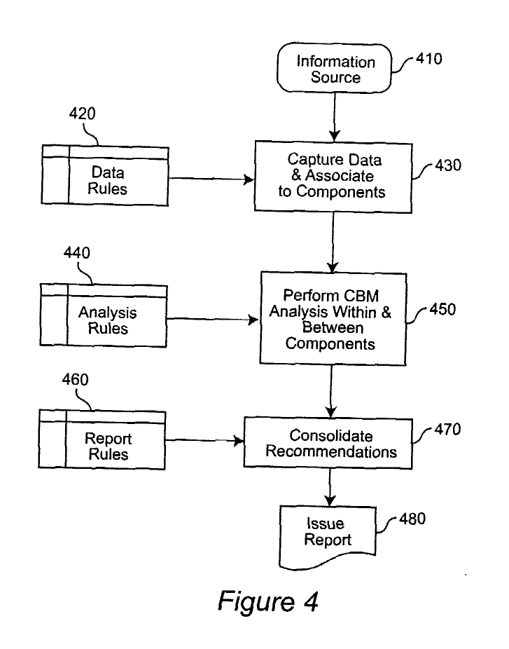

The operation of the rules implementing BSLAs, which drive the analysis of the invention, are described in FIG. 4. An information source 410 provides data to the management and control component (e.g. item 330 in FIG. 3). Data rules 420 provide for capturing the data from information source 410 and for associating the data to appropriate components 430. These rules allow the centralized service (or component, if distributed) to select only relevant data from that which is provided by information source 410. Analysis rules 440 perform CBM analysis by and between components 450. These rules specify what to do with the data, i.e. how to analyze. Then report rules 460 consolidate recommendations 470. These rules specify what actions need to be taken as a result of the analysis. Finally, a report is issued 480. The report can be in the form of a written report, action item, message, service invocation or any other mechanism for effectively directing change in the behavior of a component. For example, a message may be sent to a human manager of a component. Or a message may be sent to a software agent empowered to control a device or take any other recommended action.

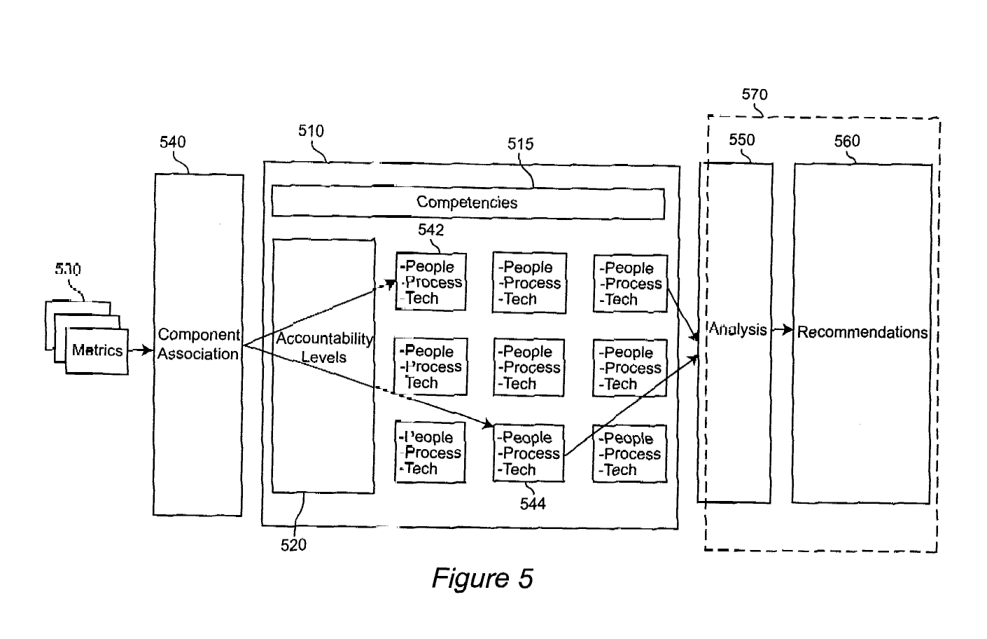

FIG. 5 shows how the invention is related to the component business model (CBM). The modular decomposition of an enterprise that CBM allows results in the identification of components (logical parts of the enterprise) that comprise the people, process and IT elements of the enterprise. The elements that are identified can be analyzed for investment, change and transformation. Further, the interaction between the components of the enterprise provides a new way of managing the business.

This is conceptualized by component map 510 with its-competencies 515 and accountability levels 540 within which are arrayed components (e.g. 542 and 544) having people, processes and technology. The metrics 530 needed to manage the enterprise are associated 540 with components, and the monitoring data from these components is then provided as a service to a management and control component (e.g. item 230 in FIG. 2) which captures and analyzes 550 the data and provides recommendations 560. The focus of the invention is the analysis and generation of recommendations and action items provided by each management and control component (e.g. item 230 in FIG. 2) in the MCG component (item 120 in FIG. 1.

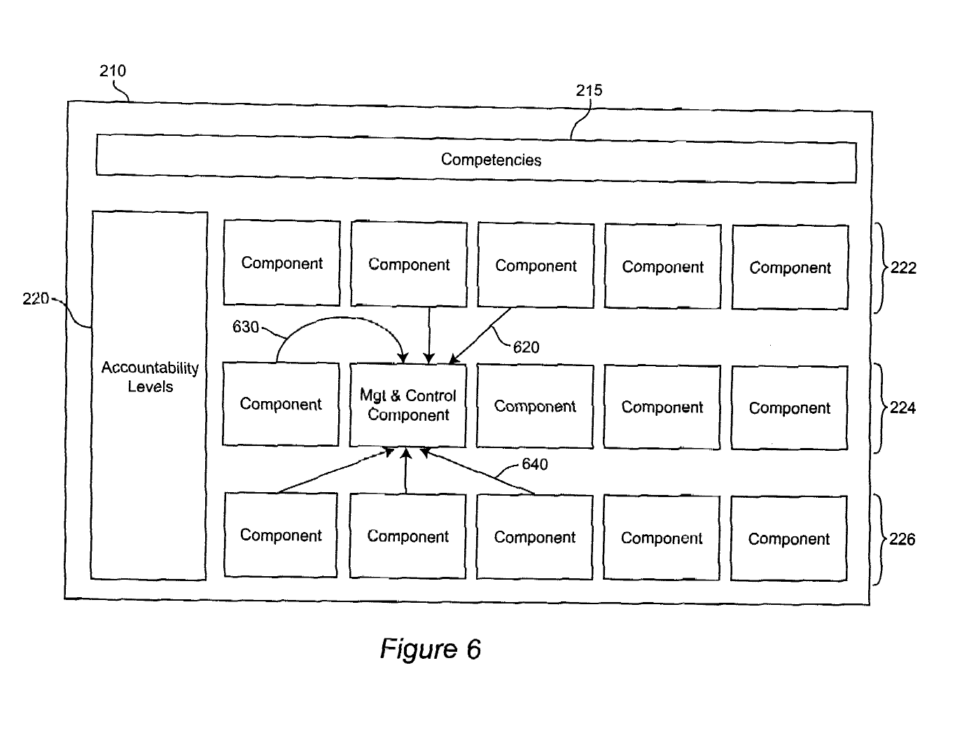

Turning now to FIG. 6 there is shown the relationship among the components controlled by a management and control component as shown in FIG. 2. Components in component map 210 are arrayed by management accountability level 220. Three such levels are provided in CBM: a control level 222 provides policy and strategy for the enterprise; a direct level 224 implements policy and strategy by directing the activities of the enterprise; an execute level 226 provides control at the operational level. Policy, strategy and rules are passed (e.g. 620) to the management and control component from control level 222 components. Exceptions are passed (e.g. 630) to the management and control component from other components at the direct level 224. Operational data is passed (e.g. 640) to the management and control component from execute level 226 components.

While the invention has been described in terms of a single preferred embodiment, those skilled in the art will recognize that the invention can be practiced with modification within the spirit and scope of the appended claims.

Having thus described my invention, what I claim as new and desire to secure by Letters Patent is as follows:

1. A method of managing an enterprise, comprising:
identifying metrics describing the enterprise;
associating the identified metrics with components in a component business model of the enterprise;
analyzing data provided by said metrics; and
recommending action by components in response to said analysis.

2. A method as in claim 1, wherein said analyzing and recommending is performed by one or more management and control components.

3. A method as in claim 2, wherein the management and control components receive all monitoring data necessary to manage the enterprise, and wherein each said management and control component is characterized by all of the following attributes:
receives monitoring data from other components;
contains a set of business rules that are executed in response to received data; and
issues invocations to other components that alter the behavior of parts of the business that were monitored by said metrics.

4. A method as in claim 3, wherein one of said invocations is a recommendation for process re-engineering of a component.

5. A method as in claim 3, wherein one of said invocations is in the form of a message to a manager of a component.

6. A system for managing an enterprise, comprising:
means for identifying metrics describing the enterprise;
means for associating the identified metrics with components in a component business model of the enterprise;
means for analyzing data provided by said metrics; and
means for recommending action by components in response to said analysis.

7. A system as in claim 6, wherein said means for analyzing and means for recommending are performed by one or more management and control components.

8. A system as in claim 7, wherein the management and control components receive all monitoring data necessary to manage the enterprise, and wherein each said management and control component is characterized by all of the following attributes:
receives monitoring data from other components;
contains a set of business rules that are executed in response to received data; and
issues invocations to other components that alter the behavior of parts of the business that were monitored by said metrics.

9. A system as in claim 8, wherein one of said invocations is a recommendation for process re-engineering of a component.

10. A system as in claim 8, wherein one of said invocations is in the form of a message to a manager of a component.

11. Implementing a service for managing a business, comprising the method of:
identifying metrics describing the enterprise;
associating the identified metrics with components in a component business model of the enterprise;
analyzing data provided by said metrics; and
recommending action by components in response to said analysis.

12. The method of implementing a service as in claim claim 11, wherein said analyzing and recommending is performed by one or more management and control components.

13. The method of implementing a service as in claim 12, wherein the management and control components receive all monitoring data necessary to manage the enterprise, and wherein each said management and control component is characterized by all of the following attributes:
receives monitoring data from other components;
contains a set of business rules that are executed in response to received data; and
issues invocations to other components that alter the behavior of parts of the business that were monitored by said metrics.

14. The method of implementing a service as in claim 12, wherein one of said invocations is a recommendation for process re-engineering of a component.

15. A method as in claim 12, wherein one of said invocations is in the form of a message to a manager of a component.

16. A computer implemented system for managing an enterprise, comprising:
first computer code for identifying metrics describing the enterprise;
second computer code for associating the identified metrics with components in a component business model of the enterprise;
third computer code for analyzing data provided by said metrics; and
fourth computer code for recommending action by components in response to said analysis.

17. A computer implemented system as in claim 16, wherein said third computer code for analyzing and said fourth computer code for recommending are implemented as services to one or more management and control components.

18. A computer implemented system as in claim 17, wherein the management and control components receive all monitoring data necessary to manage the enterprise, and wherein each said management and control component is characterized by all of the following attributes:
receives monitoring data from other components;
contains a set of business rules that are executed in response to received data; and
issues invocations to other components that alter the behavior of parts of the business that were monitored by said metrics.

19. A computer implemented system as in claim 18, wherein one of said invocations is a recommendation for process re-engineering of a component.

20. A computer implemented system as in claim 18, wherein one of said invocations is in the form of a message to a manager of a component.
